(19) United States
(12) Patent Application Publication
(10) Pub. No.: US 2021/0024756 A1
(43) Pub. Date: Jan. 28, 2021

(54) STABILIZED COPPER GLASS

(71) Applicant: CORNING INCORPORATED, CORNING, NY (US)

(72) Inventors: Caitlin Marie Clark, Corning, NY (US); Edward John Fewkes, Corning, NY (US)

(21) Appl. No.: 16/980,670

(22) PCT Filed: Mar. 14, 2019
(86) PCT No.: PCT/US2019/022239

§ 371 Date: Sep. 14, 2020

Related U.S. Application Data
(60) Provisional application No. 62/643,854, filed on Mar. 16, 2018.

(51) Int. Cl. C09D 5/14; C09D 7/61; C09D 7/63; A01N 59/20

(52) U.S. Cl. CPC C09D 5/14; C09D 7/61; C08K 3/40; A01N 59/20; C09D 7/63

(57) ABSTRACT

A paint composition is provided. The paint composition includes a solvent, a carrier, a pigment, a plurality of copper-containing glass particles, and a thiourea. The paint composition is applied to a substrate as a film and the film exhibits no mold, fungi, or bacterial growth as determined using ASTM 5590.

### CROSS REFERENCE TO RELATED APPLICATIONS

This application claims the benefit of priority of U.S. Provisional Application Ser. No. 62/643,854 filed on Mar. 16, 2018 the contents of which are relied upon and incorporated herein by reference in their entirety as if fully set forth below.

### TECHNICAL FIELD

The present invention generally relates to antimicrobial materials, and more particularly, a stabilized copper glass using thiourea to stabilize the oxidation of copper (I) in the glass.

### BACKGROUND

Drug resistant bacteria and viruses have become more prevalent with the increasing use of antibiotics. An alternative method for both killing and inhibiting the growth of bacteria and/or viruses is the use of copper and copper alloys (brass, bronze, and others). The use of copper and copper alloys for antimicrobial purposes has been used for hundreds of years, however copper and copper alloys have only recently received EPA approval with health benefit claims in 2008.

There is a need to find better methods to supply the anti-microbial properties of copper and copper alloys to environments where the inhibition of bacteria and viruses is desired or required.

### SUMMARY

According to one embodiment, a paint composition is provided. The paint composition includes a solvent, a carrier, a pigment, a plurality of copper-containing glass particles, and a thiourea. The paint composition is applied to a substrate as a film and the film exhibits no mold, fungi, or bacterial growth as determined using ASTM 5590.

According to another embodiment, a coating composition is provided. The coating composition includes a carrier, a plurality of copper-containing particles, and a thiourea. The weight ratio of copper-containing particles to thiourea is in a range from about 0.005 to about 12. The coating composition may form a film exhibiting no mold, fungi, or bacterial growth as determined using ASTM 5590.

According to yet another embodiment, an anti-microbial copper-containing glass is provided. The antimicrobial copper-containing glass includes a glass phase having more than 40 mol % SiO₂, a cuprite phase having a plurality of Cu¹⁺ ions, and a thiourea. The antimicrobial copper-containing glass has a weight ratio of anti-microbial copper glass to thiourea in a range from about 0.005 to about 12.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Additional features and advantages will be set forth in the detailed description which follows and will be apparent to those skilled in the art from the description or recognized by practicing as described in the following description together with the claims and appended drawings.

The copper in copper-containing glass can possess antimicrobial properties when in the reduced oxidation state of copper (I). Once the copper is oxidized to the copper (II) state, the antimicrobial activity declines and the copper (II) in the copper glass will shift to a blue-green color when coordinated by ammonia. The shift in color from the copper (I) colorless state to the copper (II) blue-green color can present a common problem when copper glass is used in a paint formulation. It has been surprisingly discovered that the addition of thiourea (shown below) to copper glass can help keep the copper present in a steady state of copper (I) and therefore maintain the antimicrobial activity and prevent color change.

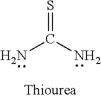

Without being bound by theory, the additional stability provided by the thiourea to the copper-containing glass is at least partially due to thiourea's functioning as a ligand for the copper (I). The thiourea ligated copper (I) does not form an excessively stable or protected complex such that the copper (I) is un-reactive. It has also been reported that thiourea will not form a stable complex with copper (II).

Referring to the disclosure herein, a paint composition is provided. The paint composition includes a solvent, a carrier, a pigment, a plurality of copper-containing glass particles, and a thiourea. The paint composition can be applied to a substrate and dried as a film or a coating. The corresponding film or coating exhibits no mold, fungi, or bacterial growth as determined using ASTM 5590.

Still referring to the disclosure herein, a coating composition is provided. In some embodiments similar to the paint composition, the coating composition includes the carrier, the plurality of copper-containing particles, and the thiourea. The weight ratio of copper-containing particles to thiourea is in a range from about 0.005 to about 12 and the coating composition may form a film exhibiting no mold, fungi, or bacterial growth as determined using ASTM 5590.

As an alternative to the plurality of copper-containing particles, an anti-microbial copper-containing glass is additionally provided herein. The antimicrobial copper-containing glass includes a glass phase having more than 40 mol % SiO₂, a cuprite phase having a plurality of Cu¹⁺ ions, and the thiourea. The antimicrobial copper-containing glass has a weight ratio of anti-microbial copper glass to thiourea in a range from about 0.005 to about 12. The anti-microbial copper-containing glass and plurality of copper-containing particles can be used or applied in a variety of different applications other than the paint compositions and coating compositions described herein as could be appreciated by one skilled in the art. For example, in some embodiments, the anti-microbial copper-containing glass could be used as an exposed surface in a medical device, cookware, drinking glasses, plates, bowls, electronic devices, windows, and/or building materials. The copper-containing particles could be used in combination with or the same or similar type of application where defined surfaces made from glass may not be required.

Biocides are commonly added to paint formulations, coatings, and other carriers to maintain the products' integrity from microbial attack and to prevent fungal and algal growth in the dry film. The addition of copper-containing glass to paints or other coating compositions, as disclosed herein, has been shown to act as a biocide. Since many currently available paints on the market contain ammonia, the color shift from copper (I) glass to copper (II) in paint formulations has presented a problem. The copper (II) ammonia complex is a deep blue color which continues to form as the paint ages. The addition of thiourea can help prevent this copper ammonium complex from forming and thereby help prevent the blue shift in the paint color. The addition of other stabilizing ligands into the paint have not provided comparable properties such as retained anti-microbial activity, despite maintaining the copper (I) oxidation state in the glass. For example, the use of cysteine as a ligand can maintain the copper (I) oxidation state in the copper glass but the anti-microbial activity is minimized.

One of the commercial benefits of using thiourea with copper-containing glass is that it affords a practical and cost-effective route to stabilize paint mixtures as well as preventing the copper (I) to copper (II) shift due to thiourea's strong complexation preference for copper (I). This color shift can be prevented using various amounts of thiourea with the copper-containing glass. For example, in some embodiments, the weight ratio of copper-containing glass to thiourea can be 1:1, 2:1, 4:1, and/or 10:1. In other embodiments, the weight ratio of copper-containing glass to thiourea can be from about 1:200 (0.005) to about 12:1 (12). In still other embodiments, the weight ratio of copper-containing glass to thiourea can be 3:1, 5:1, 6:1, 7:1, 8:1, 9:1, 11:1, 12:1, 13:1, 14:1, 15:1, 16:1, 17:1, 18:1, 19:1, 20:1, 25:1, 50:1, 75:1, 100:1, 1:100, 1:75, 1:50, 1:25, 1:20, 1:19, 1:18 1:17, 1:16, 1:15, 1:14, 1:13, 1:12, 1:11, 1:10, 1:9, 1:8, 1:7, 1:6, 1:5, 1:4, 1:3, or 1:2.

Various aspects of this disclosure describe how colorless copper-containing glass particles chelated to thiourea exhibit a white and/or colorless appearance while its antimicrobial activity meets the health benefit requirements set forth by the United States Environmental Protection Agency (EPA). Specifically, the thiourea chelated copper-containing glass particles can exhibit a kill rate of greater than 99.9% (or a log reduction of 3 or greater) within 2 hours of exposure to Staphylococcus aureus under the EPA Test Method for Efficacy of Copper Alloy as a Sanitizer testing conditions (the “EPA Test”). In some embodiments, the thiourea chelated copper-containing glass particles can kill fungi (e.g., A. pullulans and A. niger/P. funiculosum) under ASTM 5590. In some embodiments, the thiourea chelated copper-containing glass particles can kill such fungi under a zone of inhibition test, as described herein.

As used herein the term “antimicrobial,” means a material, or a surface of a material that will kill or inhibit the growth of microbes including bacteria, viruses and/or fungi. The term as used herein does not mean the material or the surface of the material will necessarily kill or inhibit the growth of all species microbes within such families, but that it will kill or inhibit the growth or one or more species of microbes from such families.

As used herein the term “log reduction” means—log (Ca/Co), where Ca=the colony form unit (CFU) number of the antimicrobial surface and Co=the colony form unit (CFU) of the control surface that is not an antimicrobial surface. As an example, a 3 log reduction equals about 99.9% of the microbes killed and a Log Reduction of 5=99.999% of microbes killed.

The solvent is a volatile liquid used to obtain desired viscosity and flow of the paint. It keeps the solid components of paint in suspension and also influences the adhesion properties of the surface. It is an optional component of paint i.e. some paints may not have solvent. The solvent after application of paint evaporates to leave a solid dry film on the surface. The most common solvents used in architectural paints are water and mineral spirits. Water is used in acrylic paints (both interior and exterior) while mineral spirits are used in oil based paints.

The binder/vehicle/resin is one of the most important and necessary components of paint. The purpose of binder in paint is to impart adhesion to the film as well as cohesion to the pigment particles. It binds the pigment particles together to from a cohesive layer after the evaporation of the solvent. It strongly influences other properties such as gloss, toughness, flexibility and durability. Linseed oil and poppy seed oil are two of the most common oils used as binders in paint. In solvent based paints the binder is usually an alkyd resin while in water based paints the binder is usually an acrylic emulsion but some vinyl emulsions are also used. The binder, or resin component is either dissolved in liquid solvent or dispersed in non-solvent. Paints that contain solid binder dissolved in a solvent and dry due to the evaporation of solvent are known as lacquers. Binders may be natural or synthetic and may include, for example, drying oil, natural resins, synthetic resins, or a combination thereof. Drying oils may include linseed oil, poppy seed oil, soybean oil, tung oil, olive oil, or a combination thereof. Natural resins may include, for example, kauri, damar, ester, lac, rubber, or a combination thereof. Synthetic resins may include, for example, epoxy, alkyl, acrylic, polyurethane, silicone, phenolic, or a combination thereof.

The pigments are granular solids which impart paint its most important properties of color and opacity. The pigments used in paint are normally present as fine solid particles that are dispersed, but not soluble, in the binder and solvent. Majority of white paints use Titanium Dioxide as a pigment. Sometimes dyes are used instead of pigments or in combination with pigments to impart color to the paint fillers are a special type of pigment that is used to thicken the film, support its structure and increase the volume of the paint. Fillers are usually cheap and used to reduce the cost of paint. They are inert materials, such as clay, lime, talc etc.

Additives are the special components of paint and are used in small quantities to impart additional characteristics to the paint. The purpose of using additives is to: 1) Improve the production and storing properties; 2) Reduce the drag of the paint; 3) Make the paint flow on a surface; 4) Add texture to the paint; 5) Enhance the adhesive characteristics for special surfaces; 6) Give pleasant odor in case of interior painting; and 7) Provide water proofing characteristics. Common types of additives may include, for example, drying/curing agents, stabilizers, anti-mold agents; wetting and dispersive additives; anti-settling additives; anti-skinning agents; or a combination thereof.

In one or more embodiments, the thiourea chelated copper-containing glass particles exhibit a greater than 3 log reduction in a concentration of Staphylococcus aureus, under the EPA Test.

In one or more embodiments, the thiourea chelated copper-containing glass particles may exhibit a 2 log reduction or greater (e.g., 4 log reduction or greater, or a 5 log reduction or greater) in a concentration of Murine Norovirus, under modified JIS Z 2801 (2000) testing conditions for evaluating viruses (hereinafter, “Modified JIS Z 2801 for Viruses”). The Modified JIS Z 2801 (2000) Test for Viruses is described in greater detail herein.

In some embodiments, the thiourea chelated copper-containing glass particles may exhibit the log reductions described herein (i.e., under the EPA Test, the Modified JIS Z 2801 Test for Bacteria and/or the Modified JIS Z 2801 Test for Viruses), for a period of one month or greater or for a period of three months or greater. The one-month period or three month period may commence at or after the application of the thiourea chelated copper-containing glass particles to a surface as a film. This film can exhibit the log reductions described herein for the disclosed bacteria and viruses.

One or more embodiments of the copper-containing glass include a Cu species. In one or more alternative embodiments, the Cu species may include Cu¹⁺, Cu⁰, and/or Cu²⁺. The combined total of the Cu species may be about 10 wt % or more. However, as will be discussed in more detail below, the amount of Cu²⁺ is minimized or is reduced such that the copper-containing glass is substantially free of Cu²⁺. The Cu¹⁺ ions may be present on or in the surface and/or the bulk of the copper-containing glass. In some embodiments, the Cu¹⁺ ions are present in a glass network and/or a glass matrix of the copper-containing glass. Where the Cu¹⁺ ions are present in the glass network, the Cu¹⁺ ions are atomically bonded to the atoms in the glass network. Where the Cu¹⁺ ions are present in the glass matrix, the Cu¹⁺ ions may be present in the form of Cu¹⁺ crystals that are dispersed in the glass matrix. In some embodiments the Cu¹⁺ crystals include cuprite (Cu₂O). In such embodiments, where Cu¹⁺ crystals are present, the material may be referred to as a copper-containing glass ceramic, which is intended to refer to a specific type of glass with crystals that may or may not be subjected to a traditional ceramming process by which one or more crystalline phases are introduced and/or generated in the glass. Where the Cu¹⁺ ions are present in a non-crystalline form, the material may be referred to as a copper-containing glass. In some embodiments, both Cu¹⁺ crystals and Cu¹⁺ ions not associated with a crystal are present in the copper-containing glasses described herein.

In one or more embodiments, the copper-containing glass may be formed from a glass composition that can include, in mole percent, SiO₂ in the range from about 30 to about 70, Al₂O₃ in the range from about 0 to about 20, a copper-containing oxide in the range from about 10 to about 50, CaO in the range from about 0 to about 15, MgO in the range from about 0 to about 15, P₂O₅ in the range from about 0 to about 25, B₂O₃ in the range from about 0 to about 25, K₂O in the range from about 0 to about 20, ZnO in the range from about 0 to about 5, Na₂O in the range from about 0 to about 20, and/or Fe₂O₃ in the range from about 0 to about 5. In such embodiments, the amount of the copper-containing oxide is greater than the amount of Al₂O₃. In some embodiments, the glass composition may include a content of R₂O, where R may include K, Na, Li, Rb, Cs and combinations thereof.

In the embodiments of the copper-containing glass compositions described herein, SiO₂ serves as the primary glass-forming oxide. The amount of SiO₂ present in the copper-containing glass composition should be enough to provide glasses that exhibit the requisite chemical durability suitable for its use or application (e.g., touch applications, article housing etc.). The upper limit of SiO₂ may be selected to control the melting temperature of the glass compositions described herein. For example, excess SiO₂ could drive the melting temperature at 200 poise to high temperatures at which defects such as fining bubbles may appear or be generated during processing and in the resulting glass. Furthermore, compared to most oxides, SiO₂ decreases the compressive stress created by an ion exchange process of the resulting glass. In other words, glass formed from glass compositions with excess SiO₂ may not be ion-exchangeable to the same degree as glass formed from copper-containing glass compositions without excess SiO₂. Additionally, or alternatively, SiO₂ present in the copper-containing glass compositions according to one or more embodiments could increase the plastic deformation prior break properties of the resulting glass. An increased SiO₂ content in the glass formed from the copper-containing glass compositions described herein may also increase the indentation fracture threshold of the glass.

In one or more embodiments, the copper-containing glass composition includes SiO₂ in an amount, in mole percent, in the range from about 30 to about 70, from about 30 to about 69, from about 30 to about 68, from about 30 to about 67, from about 30 to about 66, from about 30 to about 65, from about 30 to about 64, from about 30 to about 63, from about 30 to about 62, from about 30 to about 61, from about 30 to about 60, from about 40 to about 70, from about 45 to about 70, from about 46 to about 70, from about 48 to about 70, from about 50 to about 70, from about 41 to about 69, from about 42 to about 68, from about 43 to about 67 from about 44 to about 66 from about 45 to about 65, from about 46 to about 64, from about 47 to about 63, from about 48 to about 62, from about 49 to about 61, from about 50 to about 60 and all ranges and sub-ranges therebetween.

In one or more embodiments, the copper-containing glass composition includes Al₂O₃ an amount, in mole percent, in the range from about 0 to about 20, from about 0 to about 19, from about 0 to about 18, from about 0 to about 17, from about 0 to about 16, from about 0 to about 15, from about 0 to about 14, from about 0 to about 13, from about 0 to about 12, from about 0 to about 11 from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition is substantially free of Al₂O₃. As used herein, the phrase “substantially free” with respect to the components of the glass composition and/or resulting glass means that the component is not actively or intentionally added to the glass compositions during initial batching or subsequent post processing (e.g., ion exchange process), but may be present as an impurity. For example, in the copper-containing glass composition, the glass may be describe as being substantially free of a component, when the component is present in an amount of less than about 0.01 mol %.

The amount of Al₂O₃ may be adjusted to serve as a glass-forming oxide and/or to control the viscosity of molten glass compositions. Without being bound by theory, it is believed that when the concentration of alkali oxide (R₂O) in a glass composition is equal to or greater than the concentration of Al₂O₃, the aluminum ions are found in tetrahedral coordination with the alkali ions acting as charge-balancers. This tetrahedral coordination greatly enhances various post-processing (e.g., ion exchange process) of glasses formed from such glass compositions. Divalent cation oxides (RO) can also charge balance tetrahedral aluminum to various extents. While elements such as calcium, zinc, strontium, and barium behave equivalently to two alkali ions, the high field strength of magnesium ions causes them to not fully charge balance aluminum in tetrahedral coordination, resulting in the formation of five- and six-fold coordinated aluminum. Generally, Al₂O₃ can play an important role in ion-exchangeable glass compositions and strengthened glasses since it enables a strong network backbone (i.e., high strain point) while allowing for the relatively fast diffusivity of alkali ions. However, when the concentration of Al₂O₃ is too high, the glass composition may exhibit lower liquidus viscosity and, thus, Al₂O₃ concentration may be controlled within a reasonable range. Moreover, as will be discussed in more detail below, excess Al₂O₃ has been found to promote the formation of Cu²⁺ ions, instead of the desired Cu¹⁺ ions.

In one or more embodiments, the copper-containing glass composition includes a copper-containing oxide in an amount, in mole percent, in the range from about 10 to about 50, from about 10 to about 49, from about 10 to about 48, from about 10 to about 47, from about 10 to about 46, from about 10 to about 45, from about 10 to about 44, from about 10 to about 43, from about 10 to about 42, from about 10 to about 41, from about 10 to about 40, from about 10 to about 39, from about 10 to about 38, from about 10 to about 37, from about 10 to about 36, from about 10 to about 35, from about 10 to about 34, from about 10 to about 33, from about 10 to about 32, from about 10 to about 31, from about 10 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 11 to about 50, from about 12 to about 50, from about 13 to about 50, from about 14 to about 50, from about 15 to about 50, from about 16 to about 50, from about 17 to about 50, from about 18 to about 50, from about 19 to about 50, from about 20 to about 50, from about 10 to about 30, from about 11 to about 29, from about 12 to about 28, from about 13 to about 27, from about 14 to about 26, from about 15 to about 25, from about 16 to about 24, from about 17 to about 23, from about 18 to about 22, from about 19 to about 21 and all ranges and sub-ranges therebetween. In one or more specific embodiments, the copper-containing oxide may be present in the glass composition in an amount of about 20 mole percent, about 25 mole percent, about 30 mole percent or about 35 mole percent. The copper-containing oxide may include CuO, Cu₂O and/or combinations thereof.

The copper-containing oxides in the glass composition form the Cu¹⁺ ions present in the resulting glass. Copper may be present in the glass composition and/or the glasses including the glass composition in various forms including Cu⁰, Cu¹⁺, and Cu²⁺. Copper in the Cu⁰ or Cu¹⁺ forms provide antimicrobial activity. However, forming and maintaining these states of antimicrobial copper are difficult and often, in known glass compositions, Cu²⁺ ions are formed instead of the desired Cu⁰ or Cu¹⁺ ions.

In one or more embodiments, the amount of copper-containing oxide is greater than the amount of Al₂O₃ in the copper-containing glass composition. Without being bound by theory it is believed that an about equal amount of copper-containing oxides and Al₂O₃ in the glass composition results in the formation of tenorite (CuO) instead of cuprite (Cu₂O). The presence of tenorite decreases the amount of Cu¹⁺ in favor of Cu²⁺ and thus leads to reduced antimicrobial activity. Moreover, when the amount of copper-containing oxides is about equal to the amount of Al₂O₃, aluminum prefers to be in a four-fold coordination and the copper in the glass composition and resulting glass remains in the Cu²⁺ form so that the charge remains balanced. Where the amount of copper-containing oxide exceeds the amount of Al₂O₃, then it is believed that at least a portion of the copper is free to remain in the Cu¹⁺ state, instead of the Cu²⁺ state, and thus the presence of Cu¹⁺ ions increases.

The copper-containing glass composition of one or more embodiments includes P₂O₅ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition includes about 10 mole percent or about 5 mole percent P₂O₅ or, alternatively, may be substantially free of P₂O₅.

In one or more embodiments, P₂O₅ forms at least part of a less durable phase or a degradable phase in the glass. The relationship between the degradable phase(s) of the glass and antimicrobial activity is discussed in greater detail herein. In one or more embodiments, the amount of P₂O₅ may be adjusted to control crystallization of the glass composition and/or glass during forming. For example, when the amount of P₂O₅ is limited to about 5 mol % or less or even 10 mol % or less, crystallization may be minimized or controlled to be uniform. However, in some embodiments, the amount or uniformity of crystallization of the copper-containing glass composition and/or glass may not be of concern and thus, the amount of P₂O₅ utilized in the glass composition may be greater than 10 mol %.

In one or more embodiments, the amount of P₂O₅ in the copper-containing glass composition may be adjusted based on the desired damage resistance of the glass, despite the tendency for P₂O₅ to form a less durable phase or a degradable phase in the glass. Without being bound by theory, P₂O₅ can decrease the melting viscosity relative to SiO₂. In some instances, P₂O₅ is believed to help to suppress zircon breakdown viscosity (i.e., the viscosity at which zircon breaks down to form ZrO₂) and may be more effective in this regard than SiO₂. When glass is to be chemically strengthened via an ion exchange process, P₂O₅ can improve the diffusivity and decrease ion exchange times, when compared to other components that are sometimes characterized as network formers (e.g., SiO₂ and/or B₂O₃).

The copper-containing glass composition of one or more embodiments includes B₂O₃ in an amount, in mole percent, in the range from about 0 to about 25, from about 0 to about 22, from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition includes a non-zero amount of B₂O₃, which may be, for example, about 10 mole percent or about 5 mole percent. The copper-containing glass composition of some embodiments may be substantially free of B₂O₃.

In one or more embodiments, B₂O₃ forms a less durable phase or a degradable phase in the glass formed form the copper-containing glass composition. The relationship between the degradable phase(s) of the glass and antimicrobial activity is discussed in greater detail herein. Without being bound by theory, it is believed the inclusion of B₂O₃ in glass compositions imparts damage resistance in glasses incorporating such glass compositions, despite the tendency for B₂O₃ to form a less durable phase or a degradable phase in the glass. The copper-containing glass composition of one or more embodiments includes one or more alkali oxides (R₂O) (e.g., Li₂O, Na₂O, K₂O, Rb₂O and/or Cs₂O). In some embodiments, the alkali oxides modify the melting temperature and/or liquidus temperatures of such glass compositions. In one or more embodiments, the amount of alkali oxides may be adjusted to provide a glass composition exhibiting a low melting temperature and/or a low liquidus temperature. Without being bound by theory, the addition of alkali oxide(s) may increase the coefficient of thermal expansion (CTE) and/or lower the chemical durability of the copper-containing glasses that include such glass compositions. In some cases, these attributes may be altered dramatically by the addition of alkali oxide(s).

In some embodiments, the copper-containing glasses disclosed herein may be chemically strengthened via an ion exchange process in which the presence of a small amount of alkali oxide (such as Li₂O and Na₂O) is required to facilitate ion exchange with larger alkali ions (e.g., K⁺), for example exchanging smaller alkali ions from an copper-containing glass with larger alkali ions from a molten salt bath containing such larger alkali ions. Three types of ion exchange can generally be carried out. One such ion exchange includes a Na⁺-for-Li⁺ exchange, which results in a deep depth of layer but low compressive stress. Another such ion exchange includes a K⁺-for-Li⁺ exchange, which results in a small depth of layer but a relatively large compressive stress. A third such ion exchange includes a K⁺-for-Na⁺ exchange, which results in intermediate depth of layer and compressive stress. A sufficiently high concentration of the small alkali oxide in glass compositions may be necessary to produce a large compressive stress in the copper-containing glass including such glass compositions, since compressive stress is proportional to the number of alkali ions that are exchanged out of the copper-containing glass.

In one or more embodiments, the copper-containing glass composition includes K₂O in an amount in the range from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the glass composition includes a non-zero amount of K₂O or, alternatively, the glass composition may be substantially free, as defined herein, of K₂O. In addition to facilitating ion exchange, where applicable, in one or more embodiments, K₂O can also form a less durable phase or a degradable phase in the glass formed form the glass composition. The relationship between the degradable phase(s) of the glass and antimicrobial activity is discussed in greater detail herein.

In one or more embodiments, the copper-containing glass composition includes Na₂O in an amount in the range from about 0 to about 20, from about 0 to about 18, from about 0 to about 16, from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1, from about 0.4 to about 1, from about 0.5 to about 1, from about 0 to about 0.5, from about 0 to about 0.4, from about 0 to about 0.3, from about 0 to about 0.2, from about 0 to about 0.1, and all ranges and sub-ranges therebetween. In some embodiments, the copper-containing glass composition includes a non-zero amount of Na₂O or, alternatively, the glass composition may be substantially free, as defined herein, of Na₂O.

In one or more embodiments, the copper-containing glass composition may include one or more divalent cation oxides, such as alkaline earth oxides and/or ZnO. Such divalent cation oxides may be included to improve the melting behavior of the glass compositions. With respect to ion exchange performance, the presence of divalent cations can act to decrease alkali mobility and thus, when larger divalent cation oxides are utilized, there may be a negative effect on ion exchange performance. Furthermore, smaller divalent cation oxides generally help the compressive stress developed in an ion-exchanged glass more than the larger divalent cation oxides. Hence, divalent cation oxides such as MgO and ZnO can offer advantages with respect to improved stress relaxation, while minimizing the adverse effects on alkali diffusivity.

In one or more embodiments, the copper-containing glass composition includes CaO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition is substantially free of CaO.

In one or more embodiments, the copper-containing glass composition includes MgO in an amount, in mole percent, in the range from about 0 to about 15, from about 0 to about 14, from about 0 to about 13, from about 0 to about 12, from about 0 to about 11, from about 0 to about 10, from about 0 to about 9, from about 0 to about 8, from about 0 to about 7, from about 0 to about 6, from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition is substantially free of MgO.

The copper-containing glass composition of one or more embodiments may include ZnO in an amount, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition is substantially free of ZnO.

The copper-containing glass composition of one or more embodiments may include Fe₂O₃, in mole percent, in the range from about 0 to about 5, from about 0 to about 4, from about 0 to about 3, from about 0 to about 2, from about 0 to about 1, from about 0.1 to about 1, from about 0.2 to about 1, from about 0.3 to about 1 from about 0.4 to about 1 from about 0.5 to about 1, from about 0 to about 0.5, from about 0 to about 0.4, from about 0 to about 0.3 from about 0 to about 0.2, from about 0 to about 0.1 and all ranges and sub-ranges therebetween. In some embodiments, the copper-containing glass composition is substantially free of Fe₂O₃.

In one or more embodiments, the copper-containing glass composition may include one or more colorants. Examples of such colorants include NiO, TiO₂, Fe₂O₃, Cr₂O₃, Co₃O₄ and other known colorants. In some embodiments, the one or more colorants may be present in an amount in the range up to about 10 mol %. In some instances, the one or more colorants may be present in an amount in the range from about 0.01 mol % to about 10 mol %, from about 1 mol % to about 10 mol %, from about 2 mol % to about 10 mol %, from about 5 mol % to about 10 mol %, from about 0.01 mol % to about 8 mol %, or from about 0.01 mol % to about 5 mol %.

In one or more embodiments, the copper-containing glass composition may include one or more nucleating agents. Exemplary nucleating agents include TiO₂, ZrO₂ and other known nucleating agents in the art. The copper-containing glass composition can include one or more different nucleating agents. The nucleating agent content of the copper-containing glass composition may be in the range from about 0.01 mol % to about 1 mol %. In some instances, the nucleating agent content may be in the range from about 0.01 mol % to about 0.9 mol %, from about 0.01 mol % to about 0.8 mol %, from about 0.01 mol % to about 0.7 mol %, from about 0.01 mol % to about 0.6 mol %, from about 0.01 mol % to about 0.5 mol %, from about 0.05 mol % to about 1 mol %, from about 0.1 mol % to about 1 mol %, from about 0.2 mol % to about 1 mol %, from about 0.3 mol % to about 1 mol %, or from about 0.4 mol % to about 1 mol %, and all ranges and sub-ranges therebetween.

The glasses formed from the copper-containing glass compositions may include a plurality of Cu¹⁺ ions. In some embodiments, such Cu¹⁺ ions form part of the glass network and may be characterized as a glass modifier. Without being bound by theory, where Cu¹⁺ ions are part of the glass network, it is believed that during typical glass formation processes, the cooling step of the molten glass occurs too rapidly to allow crystallization of the copper-containing oxide (e.g., CuO and/or Cu₂O). Thus, the Cu¹⁺ remains in an amorphous state and becomes part of the glass network. In some cases, the total amount of Cu¹⁺ ions, whether they are in a crystalline phase or in the glass matrix, may be even higher, such as up to 40 mol %, up to 50 mol %, or up to 60 mol %.

In one or more embodiments, the copper-containing glasses formed form the glass compositions disclosed herein include Cu¹⁺ ions that are dispersed in the glass matrix as Cu¹⁺ crystals. In one or more embodiments, the Cu¹⁺ crystals may be present in the form of cuprite. The cuprite present in the copper-containing glass may form a phase that is distinct from the glass matrix or glass phase. In other embodiments, the cuprite may form part of or may be associated with one or more glasses phases (e.g., the durable phase described herein). The Cu¹⁺ crystals may have an average major dimension of about 5 micrometers (μm) or less, 4 micrometers (μm) or less, 3 micrometers (μm) or less, 2 micrometers (μm) or less, about 1.9 micrometers (μm) or less, about 1.8 micrometers (μm) or less, about 1.7 micrometers (μm) or less, about 1.6 micrometers (μm) or less, about 1.5 micrometers (μm) or less, about 1.4 micrometers (μm) or less, about 1.3 micrometers (μm) or less, about 1.2 micrometers (μm) or less, about 1.1 micrometers or less, 1 micrometers or less, about 0.9 micrometers (μm) or less, about 0.8 micrometers (μm) or less, about 0.7 micrometers (μm) or less, about 0.6 micrometers (μm) or less, about 0.5 micrometers (μm) or less, about 0.4 micrometers (μm) or less, about 0.3 micrometers (μm) or less, about 0.2 micrometers (μm) or less, about 0.1 micrometers (μm) or less, about 0.05 micrometers (μm) or less, and all ranges and sub-ranges therebetween. As used herein and with respect to the phrase “average major dimension”, the word “average” refers to a mean value and the word “major dimension” is the greatest dimension of the particle as measured by SEM. In some embodiments, the cuprite phase may be present in the copper-containing glass in an amount of at least about 10 wt %, at least about 15 wt %, at least about 20 wt %, at least about 25 wt % and all ranges and subranges therebetween of the copper-containing glass.

In some embodiments, the copper-containing glass may include about 70 wt % Cu¹⁺ or more and about 30 wt % of Cu²⁺ or less. The Cu²⁺ ions may be present in tenorite form and/or even in the glass (i.e., not as a crystalline phase).

In some embodiments, the total amount of Cu by wt % in the copper-containing glass may be in the range from about 10 to about 30, from about 15 to about 25, from about 11 to about 30, from about 12 to about 30, from about 13 to about 30, from about 14 to about 30, from about 15 to about 30, from about 16 to about 30, from about 17 to about 30, from about 18 to about 30, from about 19 to about 30, from about 20 to about 30, from about 10 to about 29, from about 10 to about 28, from about 10 to about 27, from about 10 to about 26, from about 10 to about 25, from about 10 to about 24, from about 10 to about 23, from about 10 to about 22, from about 10 to about 21, from about 10 to about 20, from about 16 to about 24, from about 17 to about 23, from about 18 to about 22, from about 19 to about 21 and all ranges and sub-ranges therebetween. In one or more embodiments, the ratio of Cu¹⁺ ions to the total amount Cu in the copper-containing glass is about 0.5 or greater, 0.55 or greater, 0.6 or greater, 0.65 or greater, 0.7 or greater, 0.75 or greater, 0.8 or greater, 0.85 or greater, 0.9 or greater or even 1 or greater, and all ranges and sub-ranges therebetween. The amount of Cu and the ratio of Cu¹⁺ ions to total Cu may be determined by inductively coupled plasma (ICP) techniques known in the art.

In some embodiments, the copper-containing glass may exhibit a greater amount of Cu¹⁺ and/or Cu⁰ than Cu²⁺. For example, based on the total amount of Cu¹⁺, Cu²⁺ and Cu⁰ in the glasses, the percentage of Cu¹⁺ and Cu⁰, combined, may be in the range from about 50% to about 99.9%, from about 50% to about 99%, from about 50% to about 95%, from about 50% to about 90%, from about 55% to about 99.9%, from about 60% to about 99.9%, from about 65% to about 99.9%, from about 70% to about 99.9%, from about 75% to about 99.9%, from about 80% to about 99.9%, from about 85% to about 99.9%, from about 90% to about 99.9%, from about 95% to about 99.9%, and all ranges and sub-ranges therebetween. The relative amounts of Cu¹⁺, Cu²⁺ and Cu⁰ may be determined using x-ray photoluminescence spectroscopy (XPS) techniques known in the art. The copper-containing glass comprises at least a first phase and second phase. In one or more embodiments, the copper-containing glass may include two or more phases wherein the phases differ based on the ability of the atomic bonds in the given phase to withstand interaction with a leachate. Specifically, the copper-containing glass of one or more embodiments may include a first phase that may be described as a degradable phase and a second phase that may be described as a durable phase. The phrases “first phase” and “degradable phase” may be used interchangeably. The phrases “second phase” and “durable phase” may be used interchangeably. As used herein, the term “durable” refers to the tendency of the atomic bonds of the durable phase to remain intact during and after interaction with a leachate. As used herein, the term “degradable” refers to the tendency of the atomic bonds of the degradable phase to break during and after interaction with one or more leachates. In one or more embodiments, the durable phase includes SiO₂ and the degradable phase includes at least one of B₂O₃, P₂O₅ and R₂O (where R can include any one or more of K, Na, Li, Rb, and Cs). Without being bound by theory, it is believed that the components of the degradable phase (i.e., B₂O₃, P₂O₅ and/or R₂O) more readily interact with a leachate and the bonds between these components to one another and to other components in the copper-containing glass more readily break during and after the interaction with the leachate. Leachates may include water, acids or other similar materials. In one or more embodiments, the degradable phase withstands degradation for 1 week or longer, 1 month or longer, 3 months or longer, or even 6 months or longer. In some embodiments, longevity may be characterized as maintaining antimicrobial efficacy over a specific period of time.

In one or more embodiments, the durable phase is present in an amount by weight that is greater than the amount of the degradable phase. In some instances, the degradable phase forms islands and the durable phase forms the sea surrounding the islands (i.e., the durable phase). In one or more embodiments, either one or both of the durable phase and the degradable phase may include cuprite. The cuprite in such embodiments may be dispersed in the respective phase or in both phases.

In some embodiments, phase separation occurs without any additional heat treatment of the copper-containing glass. In some embodiments, phase separation may occur during melting and may be present when the glass composition is melted at temperatures up to and including about 1600° C. or 1650° C. When the glass is cooled, the phase separation is maintained.

The copper-containing glass may be provided as a plurality of particles, a sheet, or may have another shape such as particulate (which may be hollow or solid), fibrous, and the like. In one or more embodiments, the copper-containing glass includes a surface and a surface portion extending from the surface into the copper-containing glass at a depth of about 5 nanometers (nm) or less. The surface portion may include a plurality of copper ions wherein at least 75% of the plurality of copper ions includes Cu¹⁺-ions. For example, in some instances, at least about 80%, at least about 85%, at least about 90%, at least about 95%, at least about 98%, at least about 99% or at least about 99.9% of the plurality of copper ions in the surface portion includes Cu¹⁺ ions. In some embodiments, 25% or less (e.g., 20% or less, 15% or less, 12% or less, 10% or less or 8% or less) of the plurality of copper ions in the surface portion include Cu¹⁺ ions. For example, in some instances, 20% or less, 15% or less, 10% or less, 5% or less, 2% or less, 1% or less, 0.5% or less or 0.01% or less of the plurality of copper ions in the surface portion include Cu¹⁺ ions. In some embodiments, the surface concentration of Cu¹⁺ ions in the copper-containing glass is controlled. In some instances, a Cu¹⁺ ion concentration of about 4 ppm or greater can be provided on the surface of the copper-containing glass.

The copper-containing glass of one or more embodiments may exhibit a 2 log reduction or greater (e.g., 2.5, 3, 3.5, 4, 4.5, 5, 5.5, 6, 6.5 and all ranges and sub-ranges therebetween) in a concentration of at least one of Staphylococcus aureus, Enterobacter aerogenes, Pseudomonas aeruginosa, Methicillin Resistant Staphylococcus aureus, and E. coli, under the EPA Test. In some instances, the copper-containing glass exhibits at least a 4 log reduction, a 5 log reduction or even a 6 log reduction in the concentration of at least one of Staphylococcus aureus, Enterobacter aerogenes, Pseudomonas aeruginosa bacteria, Methicillin Resistant Staphylococcus aureus, and E. coli under the EPA Test.

The glasses described herein according to one or more embodiments may exhibit a 4 log reduction or greater (e.g., 5 log reduction or greater) in a concentration of at least one of Staphylococcus aureus, Enterobacter aerogenes, Pseudomonas aeruginosa bacteria, Methicillin Resistant Staphylococcus aureus, and E. coli, under JIS Z 2801 (2000) testing conditions. One or more embodiments of the glasses described herein also exhibit a 4 log reduction or greater (e.g., 5 log reduction or greater) in a concentration of at least one of Staphylococcus aureus, Enterobacter aerogenes, Pseudomonas aeruginosa Methicillin Resistant Staphylococcus aureus, and E. coli, under the Modified JIS Z 2801 Test for Bacterial. As used herein, Modified JIS Z 2801 Test for Bacteria includes evaluating the bacteria under the standard JIS Z 2801 (2000) test with modified conditions comprising heating the glass or article to a temperature of about 23 degrees Celsius to about 37 degrees Celsius at a humidity of about 38 percent to about 42 percent for about 6 hours.

In one or more embodiments described herein, the copper-containing glasses exhibit a 2 log reduction or greater, a 3 log reduction or greater, a 4 log reduction or greater, or a 5 log reduction or greater in Murine Norovirus under a Modified JIS Z 2801 for Viruses test. The Modified JIS Z 2801 (2000) Test for Viruses includes the following procedure. For each material (e.g., the articles or glass of one or more embodiments, control materials, and any comparative glasses or articles) to be tested, three samples of the material (contained in individual sterile petri dishes) are each inoculated with a 20 μL aliquot of a test virus (where antimicrobial activity is measured) or a test medium including an organic soil load of 5% fetal bovine serum with or without the test virus (where cytotoxicity is measured). The inoculum is then covered with a film and the film is pressed down so the test virus and/or or test medium spreads over the film, but does not spread past the edge of the film. The exposure time begins when each sample was inoculated. The inoculated samples are transferred to a control chamber set to room temperature (about 20° C.) in a relative humidity of 42% for 2 hours. Exposure time with respect to control samples are discussed below. Following the 2-hour exposure time, the film is lifted off using sterile forceps and a 2.00 mL aliquot of the text virus and/or test medium is pipetted individually onto each sample of material and the underside of the film (or the side of the film exposed to the sample) used to cover each sample. The surface of each sample is individually scrapped with a sterile plastic cell scraper to collect the test virus or test medium. The test virus and/or test medium is collected (at 10⁻² dilution), mixed using a vortex type mixer and serial 10-fold dilutions are prepared. The dilutions are then assayed for antimicrobial activity and/or cytotoxicity.

To prepare a control sample for testing antimicrobial activity (which are also referred to as “zero-time virus controls”) for the Modified JIS Z 2801 Test for Viruses, three control samples (contained in individual sterile petri dishes) are each inoculated with a 20 μL aliquot of the test virus. Immediately following the incubation period, a 2.00 mL aliquot of test virus is pipetted onto each control sample. The surface of each sample was individually scrapped with a sterile plastic cell scraper to collect test virus. The test virus is collected (at 10⁻² dilution), mixed using a vortex type mixer, and serial 10-fold dilutions were prepared. The dilutions are assayed for antimicrobial activity.

To prepare controls samples for cytotoxicity (which are also referred to as “2 hour control virus”) for the Modified JIS Z 2801 Test for Viruses, one control sample (contained in an individual sterile petri dish) is inoculated with a 20 μL aliquot of a test medium containing an organic soil load (5% fetal bovine serum), without the test virus. The inoculum is covered with a film and the film is pressed so the test medium spreads over the film but does not spread past the edge of the film. The exposure time begins when each control sample is inoculated. The control sample is transferred to a controlled chamber set to room temperature (20° C.) in a relative humidity of 42% for a duration of 2 hours exposure time. Following this exposure time, the film is lifted off using sterile forceps and a 2.00 mL aliquot of the test medium is pipetted individually onto each control sample and the underside of the film (the side exposed to the sample). The surface of each sample is individually scrapped with a sterile plastic cell scraper to collect the test medium. The test medium is collected (at 10⁻² dilution), mixed using a vortex type mixer, and serial 10-fold dilutions were prepared. The dilutions were assayed for cytotoxicity.

The copper-containing glass of one or more embodiments may exhibit the log reduction described herein for long periods of time. In other words, the copper-containing glass may exhibit extended or prolonged antimicrobial efficacy. For example, in some embodiments, the copper-containing glass may exhibit the log reductions described herein under the EPA Test, the JIS Z 2801 (2000) testing conditions, the Modified JIS Z 2801 Test for Bacteria and/or the Modified JIS Z 2801 Test for Viruses for up to 1 month, up to 3 months, up to 6 months or up to 12 months after the copper-containing glass is formed or after the copper-containing glass is combined with a carrier (e.g., polymers, monomers, binders, solvents and the like). These time periods may start at or after the copper-containing glass is formed or combined with a carrier.

In some embodiments, the material kills fungi (e.g., A. pullulans and A. niger/P. funiculosum) under ASTM 5590. In some embodiments, the material kills such fungi under a zone of inhibition test, as described herein.

One or more embodiments, the copper-containing glass may exhibit a preservative function, when combined with carriers described herein. In such embodiments, the copper-containing glass may kill or eliminate, or reduce the growth of various foulants in the carrier. Foulants include fungi, bacteria, viruses and combinations thereof.

In one or more embodiments, the copper-containing glasses and/or materials described herein leach the copper ions when exposed or in contact with a leachate. In one or more embodiments, the copper-containing glass leaches only copper ions when exposed to leachates including water.

In one or more embodiments, the copper-containing glass and/or articles described herein may have a tunable antimicrobial activity release. The antimicrobial activity of the glass and/or materials may be caused by contact between the copper-containing glass and a leachate, such as water, where the leachate causes Cu¹⁺ ions to be released from the copper-containing glass. This action may be described as water solubility and the water solubility can be tuned to control the release of the Cu¹⁺ ions.

In some embodiments, where the Cu¹⁺ ions are disposed in the glass network and/or form atomic bonds with the atoms in the glass network, water or humidity breaks those bonds and the Cu¹⁺ ions available for release and may be exposed on the glass or glass ceramic surface.

In one or more embodiments, the copper-containing glass may be formed using low cost melting tanks that are typically used for melting glass compositions such as soda lime silicate. The copper-containing glass may be formed into a sheet using forming processes known in the art. For instance, example forming methods include float glass processes and down-draw processes such as fusion draw and slot draw.

After formation, the copper-containing particles may be formed into sheets and may be shaped, polished or otherwise processed for a desired end use. In some instances, the copper-containing glass may be ground to a powder or particulate form. In other embodiments, the particulate copper-containing glass may be combined with other materials or carriers into articles for various end uses. The combination of the copper-containing glass and such other materials or carriers may be suitable for injection molding, extrusion or coatings or may be drawn into fibers.

In one or more embodiments, the copper-containing glass particles may include cuprous oxide. The amount of cuprous oxide in the particles may be up to 100%. In other words, the cuprous oxide particles may exclude glass or a glass network.

In one or more embodiments, the copper-containing glass particles may have a diameter in the range from about 0.1 micrometers (μm) to about 10 micrometers (μm), from about 0.1 micrometers (μm) to about 9 micrometers (μm), from about 0.1 micrometers (μm) to about 8 micrometers (μm), from about 0.1 micrometers (μm) to about 7 micrometers (μm), from about 0.1 micrometers (μm) to about 6 micrometers (μm), from about 0.5 micrometers (μm) to about 10 micrometers (μm), from about 0.75 micrometers (μm) to about 10 micrometers (μm), from about 1 micrometers (μm) to about 10 micrometers (μm), from about 2 micrometers (μm) to about 10 micrometers (μm), from about 3 micrometers (μm) to about 10 micrometers (μm) from about 3 micrometers (μm) to about 6 micrometers (μm), from about 3.5 micrometers (μm) to about 5.5 micrometers (μm), from about 4 micrometers (μm), to about 5 micrometers (μm), and all ranges and sub-ranges therebetween. As used herein, the term “diameter” refers to the longest dimension of the particle. The particulate copper-containing glass may be substantially spherical or may have an irregular shape. The particles may be provided in a solvent and thereafter dispersed in a carrier as otherwise described herein.

In one or more embodiments, the copper-containing glass particles are present in an amount of about 20 g/gallon or less. In some instances, the copper-containing particles are present in an amount in the range from about 3.5 g/gallon to about 20 g/gallon, from about 4 g/gallon to about 20 g/gallon, from about 5 g/gallon to about 20 g/gallon, from about 6 g/gallon to about 20 g/gallon, from about 8 g/gallon to about 20 g/gallon, from about 10 g/gallon to about 20 g/gallon, from about 3.5 g/gallon to about 18 g/gallon, from about 3.5 g/gallon to about 16 g/gallon, from about 3.5 g/gallon to about 15 g/gallon, from about 3.5 g/gallon to about 14 g/gallon, from about 3.5 g/gallon to about 12 g/gallon, from about 3.5 g/gallon to about 10 g/gallon, or from about 1 g/gallon to about 4 g/gallon.

In one or more embodiments, a carrier may include polymers, monomers, binders, solvents, or a combination thereof as described herein. In a specific embodiment, the carrier is a paint that is used for application to surfaces (which may include interior or exterior surfaces).

The polymer used in the embodiments described herein can include a thermoplastic polymer, a polyolefin, a cured polymer, an ultraviolet- or UV-cured polymer, a polymer emulsion, a solvent-based polymer, and combinations thereof. Examples of suitable polymers include, without limitation: thermoplastics including polystyrene (PS), high impact PS, polycarbonate (PC), nylon (sometimes referred to as polyamide (PA)), poly(acrylonitrile-butadiene-styrene) (ABS), PC-ABS blends, polybutyleneterephthlate (PBT) and PBT co-polymers, polyethyleneterephthalate (PET) and PET co-polymers, polyolefins (PO) including polyethylenes (PE), polypropylenes (PP), cyclicpolyolefins (cyclic-PO), modified polyphenylene oxide (mPPO), polyvinylchloride (PVC), acrylic polymers including polymethyl methacrylate (PMMA), thermoplastic elastomers (TPE), thermoplastic urethanes (TPU), polyetherimide (PEI) and blends of these polymers with each other. Suitable injection moldable thermosetting polymers include epoxy, acrylic, styrenic, phenolic, melamine, urethanes, polyesters and silicone resins. In other embodiments, the polymers may be dissolved in a solvent or dispersed as a separate phase in a solvent and form a polymer emulsion, such as a latex (which is a water emulsion of a synthetic or natural rubber, or plastic obtained by polymerization and used especially in coatings (as paint) and adhesives. Polymers may include fluorinated silanes or other low friction or anti-frictive materials. The polymers can contain impact modifiers, flame retardants, UV inhibitors, antistatic agents, mold release agents, fillers including glass, metal or carbon fibers or particles (including spheres), talc, clay or mica and colorants. Specific examples of monomers include catalyst curable monomers, thermally-curable monomers, radiation-curable monomers and combinations thereof.

To improve processability, mechanical properties and interactions between the carrier and the copper-containing glass particles described herein (including any fillers and/or additives that may be used), processing agents/aids may be included in the articles described herein. Exemplary processing agents/aids can include solid or liquid materials. The processing agents/aids may provide various extrusion benefits, and may include silicone based oil, wax and free flowing fluoropolymer. In other embodiments, the processing agents/aids may include compatibilizers/coupling agents, e.g., organosilicon compounds such as organo-silanes/siloxanes that are typically used in processing of polymer composites for improving mechanical and thermal properties. Such compatibilizers/coupling agents can be used to surface modify the glass and can include (3-acryloxy-propyl)trimethoxysilane; N-(2-aminoethyl)-3-aminopropyltrimethoxysilane; 3-aminopropyltri-ethoxysilane; 3-aminopropyltrimethoxysilane; (3-glycidoxypropyl)trimethoxysilane; 3-mercapto-propyltrimethoxysilane; 3-methacryloxypropyltrimethoxysilane; and vinyltrimethoxysilane.

In some embodiments, the materials described herein may include fillers including pigments, that are typically metal based inorganics can also be added for color and other purposes, e.g., aluminum pigments, copper pigments, cobalt pigments, manganese pigments, iron pigments, titanium pigments, tin pigments, clay earth pigments (naturally formed iron oxides), carbon pigments, antimony pigments, barium pigments, and zinc pigments.

After combining the copper-containing glass described herein with the carrier, as described herein, the combination or resulting material may be formed into a desired article or be applied to a surface. Where the material includes paint, the paint may be applied to a surface as a film. Examples of such articles that may be formed using the material described herein include housings for electronic devices (e.g., mobile phones, smart phones, tablets, video players, information terminal devices, laptop computer, etc.), architectural structures (e.g., countertops or walls), appliances (e.g., cooktops, refrigerator and dishwasher doors, etc.), information displays (e.g., whiteboards), and automotive components (e.g., dashboard panels, windshields, window components, etc.).

The materials described herein may include pigments to impart color. Accordingly, the coatings or films made from such materials may exhibit a wide variety of colors, depending on the carrier color, mixture of carriers and amount of particle loading. Moreover, the materials and/or coatings described herein showed no adverse effect to paint adhesion as measured by ASTM D4541. In some instances, the adhesion of the material or coating to an underlying substrate was greater than the cohesive strength of the substrate. In other words, in testing, the adhesion between the coating or coating and the substrate was so strong that the underlying substrate failed before the coating was separated from the surface of the substrate. For example, where the substrate includes wood, the adhesion between the coating or film and the substrate may be about 300 psi or greater, 400 psi or greater, 500 psi or greater, 600 psi or greater and all ranges-sub-ranges therebetween, as measured by ASTM D4541. In some instances, the material, when applied to a substrate as a coating or film, exhibits an anti-sag index value of about 3 or greater, about 5 or greater, 7 or greater, 8 or greater, 9 or greater, 10 or greater, 11 or greater, 12 or greater, 13 or greater, 14 or greater or even 15 or greater, as measured by ASTM D4400.

The material and/or coating may exhibit sufficient durability for use in household and commercial applications. Specifically, the material, when applied to a substrate as a coating or film, exhibits a scrub resistance as measured by ASTM D4213 of about 4 or greater, 5 or greater, 6 or greater, 7 or greater and all ranges and sub-ranges therebetween.

In one or more embodiments, the material and/or coating may be resistant to moisture. For example, after exposure of the material and/or coating to an environment of up to about 95% relative humidity for 24 hours, the material and/or coating exhibited no change in antimicrobial activity.

One or more embodiments of the copper-containing glass and the carrier with a loading level of the copper-containing glass such that the material exhibits resistance or preservation against the presence or growth of foulants. Foulants include fungi, bacteria, viruses and combinations thereof. In some instances, the presence or growth of foulants in materials, such as paints, varnishes and the like, can cause color changes to the material, can degrade the integrity of the material and negatively affect various properties of the material. By including a minimum loading of copper-containing glass, (e.g., about 5 wt % or less, about 4 wt % or less, about 3 wt % or less, about 2 wt % or less, or about 1 wt % or less) to the carrier, the foulants can be eliminated or reduced. In some instances, the carrier formulation need not include certain components, when fouling is eliminated or reduced. Thus, the carrier formulations used in one or more embodiments of the materials described herein may have more flexibility and variations than previously possible, when in known materials that do not include the copper-containing glass.

A method for making the paint composition is provided. The method of making the paint composition includes combining the solvent, the carrier, the pigment, the plurality of copper-containing glass particles, and the thiourea. The paint composition can be applied to a substrates including films and the film exhibits no mold, fungi, or bacterial growth as determined using ASTM 5590. It is understood that the descriptions outlining and teaching the application of urea to the many different types of copper-containing glass previously discussed, which can be used in any combination, apply equally well, where applicable, to this method for making the paint composition.

A method for making the coating composition is provided. The method of making the coating composition includes combining the carrier, the plurality of copper-containing particles, and the thiourea. The weight ratio of copper-containing particles to thiourea is in a range from about 0.005 to about 12. The coating composition may form a film exhibiting no mold, fungi, or bacterial growth as determined using ASTM 5590. It is understood that the descriptions outlining and teaching the application of urea to the many different types of copper-containing glass previously discussed, which can be used in any combination, apply equally well, where applicable, to this method for making the coating compositions.

A method for making the antimicrobial copper-containing glass is provided. The method of making the antimicrobial copper-containing glass includes the glass phase having more than 40 mol % SiO₂, the cuprite phase having a plurality of Cu¹⁺ ions, and the thiourea. The antimicrobial copper-containing glass has a weight ratio of anti-microbial copper glass to thiourea in a range from about 0.005 to about 12. The antimicrobial copper-containing glass exhibits no mold, fungi, or bacterial growth as determined using ASTM 5590. It is understood that the descriptions outlining and teaching the application of urea to the many variants of copper-containing glass previously discussed, which can be used in any combination, apply equally well, where applicable, to this method for making the antimicrobial copper-containing glass.

It will be apparent to those skilled in the art that various modifications and variations can be made without departing from the spirit or scope of the claims.

### Examples

### Materials

The chemical reagents used are listed in Table 1 below. All chemicals were obtained from commercial supplies and used as provided without further purification.

### Methods and Procedures

See paragraphs [0057] and [0058]. ASTM 5590 is a standard accelerated test method for determining resistance of various coatings (including paints) to fungal defacement. To set up the test, an agar plug was placed at the bottom of each petri plate. A single coupon was placed with a pair of sterile forceps at the center of the agar plug (on top) with the painted surface facing upwards. Each petri plate was inoculated with 150 μl of organism (1×10⁶ cfu/ml) making sure that the whole surface (paint film as well as the agar surrounding it) was evenly covered. The plates were incubated at 30° C. in presence of moisture, for a period of three weeks. The total percent area covered was evaluated and recorded at the end of each week after the 2^{nd} week and recorded in increments of 5%.

Preparation of Copper Particle and Thiourea Aqueous Solutions A series of copper glass slurries were prepared for both color evaluation and anti-microbial activity. Thiourea (2.0 g, 1.0 g, 0.5 g, or 0.2 g) was added to a glass jar and then swirled and sonicated in 20.0 mL of distilled water to completely dissolve the solid thiourea. Copper-containing glass particles (2.0 g) were then added to each of the four aqueous solutions of dissolved thiourea and swirled and sonicated. The four copper-containing glass particle and thiourea aqueous solutions were labeled in reference to the copper-containing glass particles:thiourea weight ratios. For example, the aqueous solution having 2.0 g copper-containing glass particles and 2.0 g thiourea was labeled 1:1. The other aqueous solutions prepared had 2:1, 4:1, and 10:1 weight ratios. A control sample was prepared having 2.0 g of copper-containing glass particles and no thiourea.

### Color Evaluation of Copper Particle and Thiourea Aqueous Solutions Using Ammonium Chloride

Two drops of concentrated ammonium chloride was added to 2 mL of each of the control, 1:1, 2:1, 4:1, and 10:1 aqueous solutions of copper-containing glass particles and copper-containing glass particles with thiourea. Each of the samples was shaken vigorously to disperse the respective aqueous solutions and images were taken at various time increments to monitor the respective color changes. After the initial mixing and the start of color monitoring, each of the five slurries had a brown color. After 60 minutes, the control sample had a clear blue color while each of the four thiourea slurries maintained the brown color with no signs of a blue color shift. A summary of the noted color shifts in provided in Table 1 below.

TABLE 1
Blue color shift of the Cu-Glass:Thiourea slurries and their
respective log kill or antimicrobial (AM) activity.

| | Blue Color Shift in | Antimicrobial |
|---|---|---|
| Cu-Glass:Thiourea | Ammonium Hydroxide | (AM) activity |
| (g) | with a pH 9 | (Log Kill) |
| 1:1 | − | 1.61 |
| 2:1 | − | 2.10 |
| 4:1 | − | 1.3 |
| 10:1 | − | 2.63 |
| 1:0 | + | 2/47 |

### Anti-Microbial Activity of the Copper Particle and Thiourea Aqueous Solutions

The remaining 18 mL of the control, 1:1, 2:1, 4:1, and 10:1 aqueous solutions of copper particles and copper particle with thiourea were centrifuged to remove excess water and then placed in a −80° C. freezer for about 4 hrs and place on a lyophilizer overnight. The fully dried copper particles or copper particles with bound thiourea were then added to a paint to test for anti-microbial activity by measuring the log kill by standard assay methods of the dried paint films using Escherichia coli. As shown in Table 1 above and Table 2 below, the data shows that even at low concentrations of thiourea, the anti-microbial activity is comparable to the control.

TABLE 2
The log kill (AM activity) of the Cu-Glass:Thiourea
slurries versus the copper (I) glass control.

| Minimum Inhibition Concentration | | | | | | |
|---|---|---|---|---|---|---|
| | E. coli: OD - 0.441, | | | | | |
| | 2.68 × 10\hat{ }8 cell/mL | | | | | |
| ppm | Cu + | Thiourea | 1:1 | 2:1 | 4:1 | 10:1 |
| (mg/L) | Ctrl | Ctrl | Thiourea | Thiourea | Thiourea | Thiourea |
| 1000000 | − | − | − | − | − | − |
| 100000 | − | +++ | − | − | − | − |
| 10000 | + | +++ | − | + | − | − |
| 1000 | +++ | +++ | +++ | +++ | ++ | +++ |
| 100 | +++ | +++ | +++ | +++ | +++ | +++ |
| 10 | +++ | +++ | +++ | +++ | +++ | +++ |
| 1 | +++ | +++ | +++ | +++ | +++ | +++ |
| 0.1 | +++ | +++ | +++ | +++ | +++ | +++ |
| 0.01 | +++ | +++ | +++ | +++ | +++ | +++ |
| 0.001 | +++ | +++ | +++ | +++ | +++ | +++ |
| 0.0001 | +++ | +++ | +++ | +++ | +++ | +++ |
| 0 | +++ | +++ | +++ | +++ | +++ | +++ |

− = No bacterial recovery.
+ = Trace of contamination (<10colonies).
++ = Light contamination (>100 colonies).
+++ = Heavy contamination (continuous smear of growth)

### Color Evaluation of Copper Particle and Thiourea Paint Samples

The paint formulations using the control, 1:1, 2:1, 4:1, and 10:1 of the fully dried copper particles or copper particles with bound thiourea were applied to a substrate and dried. The paint coating having no copper particles and/or thiourea had a white color while the paint coating having the control copper particles had a yellow hue. Each of the 1:1, 2:1, 4:1, and 10:1 dried paint samples had a slightly decreasing grey hue as the ratio of copper particles to thiourea increased. The color evaluation of the various copper particles with thiourea in paint demonstrates that the copper (I) glass does not have a negative impact on the color of paints which may be beneficial for a paint manufacturer when trying to make colors that additionally provide anti-microbial activity.

### Listing of Non-Limiting Embodiments

Embodiment A is a paint composition comprising: a solvent; a carrier; a pigment; a plurality of copper-containing glass particles; and a thiourea.

The composition of Embodiment A wherein the paint composition is applied to a substrate as a film and wherein the film exhibits no mold, fungi, or bacterial growth as determined using ASTM 5590.

The composition of Embodiment A or Embodiment A with any of the intervening features wherein the plurality of copper-containing glass particles to the thiourea has a weight ratio from 1 to 10.

The composition of Embodiment A or Embodiment A with any of the intervening features further comprising zinc (Zn).

The composition of Embodiment A or Embodiment A with any of the intervening features wherein the plurality of copper-containing glass particles comprise a glass phase having more than 40 mol % SiO₂ and a cuprite phase having a plurality of Cu¹⁺ ions.

The composition of Embodiment A or Embodiment A with any of the intervening features wherein the cuprite phase is dispersed in the glass phase.

The composition of Embodiment A or Embodiment A with any of the intervening features wherein the plurality of copper-containing glass particles comprises a cuprite phase comprising a plurality of Cu¹⁺ ions, and comprising at least one of B₂O₃, P₂O₅ and R₂O.

The composition of Embodiment A or Embodiment A with any of the intervening features wherein the paint composition exhibits a greater than 3 log reduction in a concentration of Staphylococcus aureus, under the EPA Test Method for Efficacy of Copper Alloy as a Sanitizer testing conditions.

Embodiment B is a coating composition comprising: a carrier; a plurality of copper-containing particles; and a thiourea; wherein the weight ratio of copper-containing particles to thiourea is in a range from about 0.005 to about 12.

The composition of Embodiment B wherein the carrier comprises a polymer, a monomer, a binder, a solvent, or a combination thereof.

The composition of Embodiment B or Embodiment B with any of the intervening features wherein the plurality of copper-containing particles comprise a glass phase having more than 40 mol % SiO₂ and a cuprite phase having a plurality of Cu¹⁺ ions.

The composition of Embodiment B or Embodiment B with any of the intervening features wherein the coating composition exhibits a greater than 3 log reduction in a concentration of Staphylococcus aureus, under the EPA Test Method for Efficacy of Copper Alloy as a Sanitizer testing conditions.

The composition of Embodiment B or Embodiment B with any of the intervening features wherein the copper-containing particles comprise either one or both of copper-containing glass and cuprous oxide.

The composition of Embodiment B or Embodiment B with any of the intervening features wherein the copper-containing particles are present in an amount of about 20 g/gallon or less.

The composition of Embodiment B or Embodiment B with any of the intervening features wherein the carrier comprises a paint.

Embodiment C is an anti-microbial copper-containing glass comprising: a glass phase having more than 40 mol % SiO₂; a cuprite phase having a plurality of Cu¹⁺ ions; a thiourea; and a weight ratio of anti-microbial copper glass to thiourea in a range from about 0.005 to about 12.

The composition of Embodiment C wherein the anti-microbial copper glass are present in a paint.

The composition of Embodiment C or Embodiment C with any of the intervening features wherein the anti-microbial copper-containing glass exhibits a greater than 3 log reduction in a concentration of Staphylococcus aureus, under the EPA Test Method for Efficacy of Copper Alloy as a Sanitizer testing conditions.

The composition of Embodiment C or Embodiment C with any of the intervening features wherein the anti-microbial copper-containing glass exhibits no mold, fungi, or bacterial growth as determined using ASTM 5590.

The composition of Embodiment C or Embodiment C with any of the intervening features wherein the cuprite phase is dispersed in the glass phase.

1. A paint composition comprising:
a solvent;
a carrier;
a pigment;
a plurality of copper-containing glass particles; and
a thiourea.

2. The paint composition of claim 1, wherein the paint composition is applied to a substrate as a film and wherein the film exhibits no mold, fungi, or bacterial growth as determined using ASTM 5590.

3. The paint composition of claim 1, wherein the plurality of copper-containing glass particles to the thiourea has a weight ratio from 1 to 10.

4. The paint composition of claim 1, further comprising zinc (Zn).

5. The paint composition of claim 1, wherein the plurality of copper-containing glass particles comprise a glass phase having more than 40 mol % SiO₂ and a cuprite phase having a plurality of Cu¹⁺ ions.

6. The paint composition of claim 1, wherein the cuprite phase is dispersed in the glass phase.

7. The paint composition of claim 1, wherein the plurality of copper-containing glass particles comprises a cuprite phase comprising a plurality of Cu¹⁺ ions, and comprising at least one of B₂O₃, P₂O₅ and R₂O.

8. The paint composition of claim 1, wherein the paint composition exhibits a greater than 3 log reduction in a concentration of Staphylococcus aureus, under the EPA Test Method for Efficacy of Copper Alloy as a Sanitizer testing conditions.

9. An antimicrobial coating composition comprising:
a carrier;
a plurality of copper-containing particles comprising either one or both of copper-containing glass and cuprous oxide; and
a thiourea;
wherein the weight ratio of copper-containing particles to thiourea is in a range from about 0.005 to about 12.

10. The coating composition of claim 9, wherein the carrier comprises a polymer, a monomer, a binder, a solvent, or a combination thereof.

11. The coating composition of claim 9, wherein the plurality of copper-containing particles comprise a glass phase having more than 40 mol % SiO₂ and a cuprite phase having a plurality of Cu¹⁺ ions.

12. The coating composition of claim 9, wherein the coating composition exhibits a greater than 3 log reduction in a concentration of Staphylococcus aureus, under the EPA Test Method for Efficacy of Copper Alloy as a Sanitizer testing conditions.

13. The material of claim 9, wherein the copper-containing particles comprise cuprous oxide.

14. The coating composition of claim 9, wherein the copper-containing particles are present in an amount of about 20 g/gallon or less.

15. The coating composition of claim 9, wherein the carrier comprises a paint.

16. An anti-microbial copper-containing material comprising:
a copper-containing glass comprising a glass phase having more than 40 mol % SiO₂;
a cuprite phase having a plurality of Cu¹⁺ ions;
a thiourea; and
a weight ratio of the copper-containing glass to thiourea in a range from about 0.005 to about 12.

17. A paint comprising the anti-microbial copper-containing material of claim 16.

18. The anti-microbial copper-containing material of claim 16 exhibiting a greater than 3 log reduction in a concentration of Staphylococcus aureus, under the EPA Test Method for Efficacy of Copper Alloy as a Sanitizer testing conditions.

19. The anti-microbial copper-containing material of claim 16 exhibiting no mold, fungi, or bacterial growth as determined using ASTM 5590.

20. The anti-microbial copper-containing material of claim 16, wherein the cuprite phase is dispersed in the glass phase.
